(19) United States
(12) Patent Application Publication
(10) Pub. No.: US 2001/0012057 A1
(43) Pub. Date: Aug. 9, 2001

(54) FILM SCANNER WITH VARIABLE IMAGE RESOLUTION

(75) Inventors: REIHARD FACH, GREISHEIM (DD); MICHAEL BROSAMLE, WEITERSTADT (DD); UWE BRAHLER, HEIDELBERG (DD)

Correspondence Address: CORPORATE PATENT COUNSEL, U S PHILIPS CORPORATION, 580 WHITE PLAINS ROAD, TARRYTOWN, NY, 10591

(73) Assignee: U.S. PHILIPS CORPORATION

(21) Appl. No.: 08/924,868

(22) Filed: Sep. 5, 1997

(30) Foreign Application Priority Data
Sep. 12, 1996 (DE) 19637137.6

(51) Int. Cl. H04N 5/253

(52) U.S. Cl. 348/97

(57) ABSTRACT

The invention relates to a film scanner comprising at least a first frame store (5) for storing the digitized pixel data of a scanned film frame, and at least a control device (6) for reading the relevant pixel data of a frame section of the stored film frame from the first frame store (5). To generate output frames in an arbitrary format and resolution, which may be used, for example for further processing in real-time multimedia applications, the control device (6) in the film scanner is provided with an arithmetic-logic unit for generating an output frame in a given size, a given aspect ratio and a given number of pixels per output frame line and lines per output frame by computing new pixels. By determining the format, particularly the resolution, for the output frame already during the scanning process, a direct further processing on computer panels or in multimedia applications is made possible. The transfer rate and the capacity required for storing the data are also reduced in this way.

### DESCRIPTION

The invention relates to a film scanner comprising at least a first frame store for storing the digitized pixel data of a scanned film frame, and at least a control device for reading the pixel data of a frame section of the stored film frame from the first frame store.

Known film scanners scan the consecutive frames of a continuously moving cinematographic film by means of an opto-electronic transducer and generate a video signal modulated in accordance with the image information of the film frames, which video signal complies with a given television transmission standard (for example, NTSC, PAL, SECAM). It is possible to modify the format of the generated TV images (television signals) in such a way that a given range of the scanned film frame is selected from which a television image is generated in a given aspect ratio. To this end, the image information data of the scanned film frame are stored in a frame store and the selected range is read by means of the control device for further processing. The television image is then supplied in the form of a standardized television signal for transmission or for storage on a suitable medium. When frames have to be generated in a different format which is suitable, for example for further processing in a computer, the pixel resolution must be adapted accordingly. To this end, the state-of-the-art film frames must be scanned by devices referred to as frame grabbers or scanners which operate at a very slow rate. This leads to a delay, which renders real-time processing during scanning of a film impossible.

It is an object of the invention to provide a film scanner which generates output frames in an arbitrary format and resolution which can be used in real time, for example for further processing in multimedia applications.

According to the invention, this object is solved in that the control device is provided with an arithmetic-logic unit for generating an output frame in a given size, a given aspect ratio and a given number of pixels per output frame line and lines per output frame by computing new pixels. The control device coupled to the first frame store reads the pixel data of a frame section from the first frame store in which preferably the pixel data of a completely scanned film frame are stored. This section may be selected in length and size within the complete film frame. Within the control device, the arithmetic-logic unit processes the selected pixel data to an output frame whose size and aspect ratio can be freely chosen. To this end, the section is not only enlarged or reduced (zooming) but may also be changed in shape (sizing). For example, a square frame section which covers approximately 30% of the film frame can be processed to a rectangular output frame with an aspect ratio of 16:9 and in many sizes. To be able to use the output frame for a maximal number of applications, the resolution may also be varied so that practically all necessary formats for the output frame are possible. For varying the resolution, the number of pixels in an output frame line as well as the number of lines per output frame can be changed. For the output frame resolution which is arbitrarily selectable in this way, new pixels are computed by the arithmetic-logic unit. To this end, image processing procedures as employed in image post-processing methods, may be used.

In a preferred further embodiment of the invention, the arithmetic-logic unit comprises at least a filter circuit for forming new pixels for the output frame in at least one dimension by means of interpolation methods, and at least a mirror circuit for mirroring the frame section on at least one of its diagonals. For computing the data of the new pixels, the arithmetic-logic unit preferably comprises integrated filter circuits which form the data of these pixels referred to as intermediate pixels by means of interpolation methods (for example, multiphase FIR filters). To this end, for example, the horizontal lines of the frame section are first processed dependent on the selected format for the output frame. Dependent on the selected enlargement or reduction, extra pixels are added or superfluous pixels are modified by means of the interpolation method. Dependent on the selected resolution, a corresponding number of intermediate values (intermediate pixels) are added and, for computing these new pixels between neighboring pixels (for example, 8), they are interpolated from the adjacent pixels of the original frame section. Subsequently, the frame is rotated 90° in a mirror circuit by mirroring the pixels on a frame diagonal. In this way, the originally vertical lines of the frame section can be processed in the same way with the same filter circuit which is realized, for example by a filter component having a horizontal orientation. A new mirroring of the frame on the frame diagonals then follows so that the selected frame section is obtained in the selected format and with the corresponding new pixels. Instead of the method described above, a filter circuit having a two-dimensional orientation may be used alternatively, which circuit simultaneously computes the required new pixels in two dimensions so that it is not necessary to mirror the frame. A further possibility of computing the required data may be provided by suitable software on a correspondingly powerful microcomputer so as to guarantee the computation during the continuous film scanning in real time.

In an advantageous embodiment of the invention, a second frame store for reading in an output frame is provided. Instead of a direct output of the data of the generated output frame, a second frame store may be coupled to the control device. The data of the output frame are thus available in a buffer or temporary store which, dependent on an arbitrary transfer mode, can be read out accordingly.

In a further embodiment, at least an input unit for supplying control parameters for the arithmetic-logic unit is provided for the size and position of the frame section, the size and aspect ratio of the output frame, the number of pixels per output frame line and the number of lines per output frame. Control parameters controlling the processing of the film frames can be applied to the film scanner via the input unit. During film scanning, the frame section to be processed can be chosen within the scanned film frame in this manner. Moreover, the format of the output frame can be controlled. In this way, all possible formats for the output frame can be configured by means of a simple control with a direct effect on the corresponding parameters.

In one embodiment, the input unit has a keyboard which is provided for entering numerical values and for selecting preferred formats for the aspect ratio and the resolution of the relevant output frame. Arbitrary numerical values for the control parameters can be directly entered via the keyboard, while settings which are often required can be directly selected as preferred formats. The values can be entered by means of a PC and suitable software transferring the supplied values to the arithmetic-logic unit. Values may also be entered, for example by means of a mouse via a menu controlled operating panel.

In one embodiment, preferred formats are aspect ratios and resolutions of 4:3 with 720*540 pixels, 16:9 with 720*405 pixels and 16:9 with 1920*1080 pixels. The preferred formats are formats which are often used, in which the control parameters are predetermined both for the aspect ratio and the number of pixels per line and lines per frame for the format of the output frames.

These and other aspects of the invention are apparent from and will be elucidated with reference to the embodiments described hereinafter.

In the drawing:

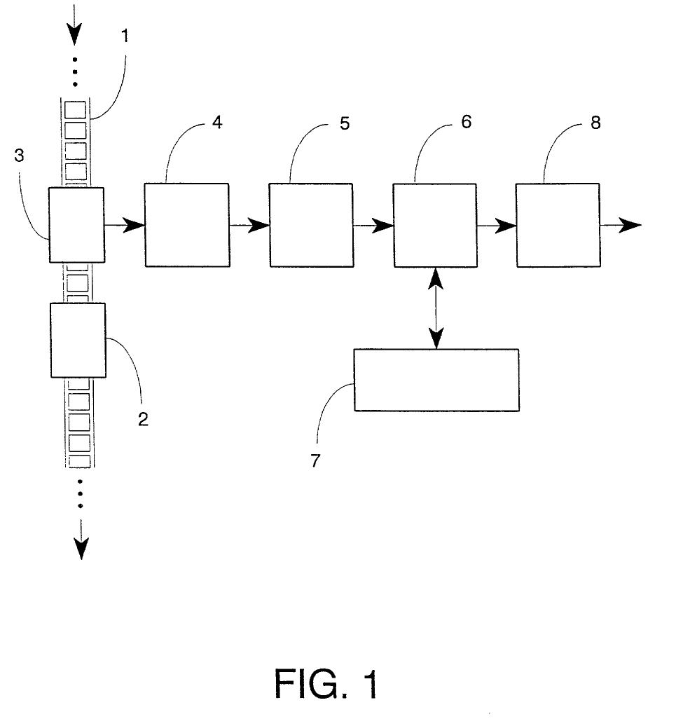

FIG. 1 shows a block diagram with the functional blocks used.

FIG. 1 shows how a film 1 is moved through an opto-electronic transducer 3 by means of a transport device 2. The transport device 2 moves the film 1 in a continuous movement along the sensors of the opto-electronic transducer 3 in which the film is scanned and the image signals are generated. The image signals are digitized in an A/D converter 4, while the amplitude quantization is not determined by a television standard but by the maximal scanner resolution. The digital pixel data, formed in the A/D converter 4, of a scanned film frame are stored in a first frame store 5. A control device 6 is coupled to the first frame store 5 and an input unit 7. Furthermore, a second frame store 8 is coupled to the control device 6.

The control device 6 receives control parameters in the form of numerical values from the input unit 7. The input unit 7 is implemented in such a way that a menu-controlled operating panel on a display screen is operated via a keyboard and/or a mouse. First, a frame section is selected from the film frame stored in the frame store 5. Both the location within the film frame and the dimensions can be freely chosen. The control device 6 subsequently reads only the data of the relevant pixels from the first frame store 5. Instead of the data of a complete film frame, only the data which are actually required are transferred and further processed in this way, so that transfer and storage capacities can be utilized more efficiently. The data are applied within the control device 6 of the film scanner to an arithmetic-logic unit which performs the following processing operation of the pixel data. In the further processing operation, a given aspect ratio and a given size may be selected for the output frame. Similarly as in the manner described above, the corresponding control parameters are also applied via the input unit 7. Furthermore, control parameters in the form of numerical values are supplied, with which a given resolution of the output frame is selected. This means that a value is supplied for the desired number of pixels per line in the output frame and a value is supplied for the desired number of lines per output frame. The user then has control parameters at his disposal, with which parameters the film scanner generates a sequence of images from a film in an individual format in real time.

Within the control device 6, the arithmetic-logic unit processes the frame section read from the first frame store 5 in accordance with the control parameters supplied. To generate an output frame having the desired dimensions and resolution, the arithmetic-logic unit operates as a two-dimensional interpolator which computes the required new pixels from the available data by means of interpolation. To this end, the pixel data of the section are first applied to a multiphase FIR filter. With this filter, a given output raster can be generated from a pixel sequence with the input raster 1, 2, 3, . . . via the control parameters of the phase (for example, at a phase 0.4 between the pixel values 3 and 5, an output raster of . . . 3.4, 3.8, 4.2, 4.6, 5, . . . is generated). An address generator retrieves the data of the corresponding pixels from the first frame store 5 by means of the input raster and interpolates between the values of the 8 neighboring pixels (for example, the values for the RGB signal). This interpolation is effected in a dimension in which the corresponding new pixels are added when, for example, extra pixels are required for the output frame when the frame section is enlarged. In the case of an accumulation in one dimension, a correspondingly large number of pixels for the output frame is omitted and, if required, new pixels are added for adapting the image contents of the section to the selected format of the output frame.

The horizontal lines of the two-dimensional field of pixel data of the selected section are first consecutively processed in the filter which generates the corresponding intermediate values (intermediate pixels) and produces the selected format of the output frame for these lines. Subsequently, the two-dimensional field of pixel data is mirrored on its diagonals in a further integrated component and the field obtained is again applied to the multiphase FIR filter. The originally vertical lines are now processed as horizontal lines, also as described above. Now, however, other parameters may be used for the conversion when a different format has been selected and set per control parameter for the output frame in this dimension. Subsequently, the two-dimensional field is mirrored on the diagonals again so that pixel data for the output frame are present in the selected format. With this hardware realization, using integrated components, a slow process in which a corresponding algorithm is realized by means of software and is run on a computer, is avoided. In the currently available microprocessors, the hardware solution is about a factor of 1000 faster and thus provides the possibility of a real-time operation of the arithmetic-logic unit during the scanning process.

The pixel data are then applied to the second frame store 8 which stores the output frame. The second frame store 8 can be read out via a corresponding data interface on the film scanner. Because of the frame store 8, which operates as a buffer store, the transfer mode is independent of the output and speed of the control device 6. For a further processing of the data, only the part which is accurately required should be transferred. The transfer rate is not only reduced in this way, but the capacity required for storing the data is also reduced. Moreover, a direct further processing on computer panels or in multimedia applications is made possible for the output frame already during the scanning process by determining the format, particularly the resolution.

1. A film scanner comprising
at least a first frame store (5) for storing the digitized pixel data of a scanned film frame, and
at least a control device (6) for reading the relevant pixel data of a frame section of the stored film frame from the first frame store (5), characterized in that the control device (6) is provided with an arithmetic-logic unit for generating an output frame in a given size, a given aspect ratio and a given number of pixels per output frame line and lines per output frame by computing new pixels.

2. A film scanner as claimed in claim 1, characterized in that the arithmetic-logic unit comprises at least a filter circuit for forming new pixels for the output frame in at least one dimension by means of interpolation methods, and at least a mirror circuit for mirroring the frame section on at least one of its diagonals.

3. A film scanner as claimed in claim 1 or 2, characterized in that a second frame store (8) for reading in an output frame is provided.

4. A film scanner as claimed in any one of claims 1 to 3, characterized in that at least an input unit (7) for supplying control parameters for the arithmetic-logic unit is provided for the size and position of the frame section, for the size and aspect ratio of the output frame, for the number of pixels per output frame line and for the number of lines per output frame.

5. A film scanner as claimed in claim 4, characterized in that the input unit (7) has a keyboard which is provided for entering numerical values and for selecting preferred formats for the aspect ratio and the resolution of the relevant output frame.

6. A film scanner as claimed in claim 5, characterized in that aspect ratios and resolutions of 4:3 with 720*540 pixels, 16:9 with 720*405 pixels and 16:9 with 1920*1080 pixels are provided as preferred formats.
